(19) United States
(12) Patent Application Publication
(10) Pub. No.: US 2004/0232775 A1
(43) Pub. Date: Nov. 25, 2004

(54) Lighting system comprised of a unique direct current power supply and a plurality of gas discharge luminaires

(76) Inventor: Ole K. Nilssen, Barrington, IL (US)

Correspondence Address: Ole K. Nilssen, 408 Caesar Drive, Barrington, IL, 60010, US

(21) Appl. No.: 10/440,527

(22) Filed: May 19, 2003

(51) Int. Cl. H02J 3/02

(52) U.S. Cl. 307/22

(57) ABSTRACT

A lighting system having one or more voltage conditioners which are connected to a power line, each conditioner providing multiple output ports into which various types of luminaries may be connected. The voltage conditioner comprises an AC-DC converter and is constructed such that the power line connection is filtered to reduce electromagnetic emanations and provides a DC voltage at one or more pairs of terminals from which no more than a manifestly limited amount of power can be drawn, thereby reducing the fire initiation hazard of the lighting system.

### FIELD OF THE INVENTION

The present invention generally relates to a lighting system used in such places as offices, hotels, homes, and, in particular, to a lighting system comprised of at least one power supply which receives electrical power from the AC mains and provides at least one output port at which a direct current or “DC” voltage is provided and controlled as to manifestly limit the magnitude of the current and power extractable so as to make any circuit(s) connected therewith safe from fire initiation hazards, thereby permitting circuits connected with said output port to be constructed and/or used in a manner which, from the perspective of fire-initiation hazards, would not have been permissible and/or commercially feasible if the output port had not been so controlled. The lighting system also includes one or more luminaires connected to an output port by means of an electrical cable with two insulated conductors.

### BACKGROUND OF THE INVENTION

Prior art related to instant invention may be found in the following U.S. patents, all issued to Ole K. Nilssen, the maker of instant invention: U.S. Pat. No. 4,598,232; 4,626,747; 4,626,953; 4,632,648; 4,634,932; 4,651,059; 4,667,133; 4,835,915; 4,970,438; 4,972,126; 5,003,227; 5,021,717; 5,047,696; 5,068,890; 5,070,522; 5,146,139; 5,210,788; 5,387,845; 5,479,326; 5,510,580; 5,559,393; 5,640,069; 5,691,603; 5,757,144; 5,977,721; and 5,998,636.

A lighting system is typically adapted to receive electrical power of the alternating current or “AC” type, to convert this received power to a lower voltage “AC” and/or a high frequency “AC”, and to selectively communicate the converted electrical power to one or more luminaires designed for a specific task or utilization. Particularly, the systems are used for out-of-doors patio and sidewalk lighting or they may incorporate a track for distributing power to small, repositionable luminaires. While the foregoing typical lighting systems do desirably convert electrical power and communicate such electrical power to a luminaire, it does have some drawbacks.

By way of example and without limitation, the foregoing lighting systems do not limit the magnitude of the electrical current or the amount of the electrical power which is supplied to the at least one luminaire. Thus, a fault in the distribution means or in the luminaire poses a shock and/or fire hazard.

The present invention overcomes these and other drawbacks associated with the foregoing typical or conventional lighting systems and by way of example and without limitation, substantially reduces the likelihood of the occurrence of a shock or fire initiation hazard.

### SUMMARY OF THE INVENTION

A lighting system is comprised of one or more voltage conditioners connected to an electrical power line. Each voltage conditioner includes at least one output port into which at least one of various types of luminaires may be connected. The voltage conditioner is an AC-DC converter and is constructed such that it can readily be mounted upon a junction box, thereby to constitute the cover therefore, or be mounted remotely. It is powered by connection with electrical power line wires with the power line connection being filtered to reduce electromagnetic emanations generated by the AC-DC converter and superimposed on the power lines to an acceptable level by an electromagnetic interference (“EMI”) filter. When so connected, the AC-DC converter will provide a DC output voltage at one or more pairs of output terminals from which no more than a manifestly limited amount of power can be drawn; thereby rendering the output terminals, and/or any circuit or load connected therewith, is safe from fire initiation hazard and thus classifiable as a Class 2 or a Class 3 circuit under the rules of the National Electrical Code. Each pair of output terminals is connected to an EMI filter. The output of the EMI filter is terminated at a modular connector and will be referred to as an output port.

The output ports are each selectively coupled to at least one luminaire. Particularly, each luminaire has a pair of input terminals, one or more gas discharge lamps, an EMI filter circuit connected to the input terminals, and a combination voltage transformation and current-limiting circuit connected between the EMI filter and the gas discharge lamp(s).

It is a first non-limiting advantage of the present invention to provide a lighting system. Particularly, the lighting system includes a converter portion which is electrically coupled to the power line voltage and which includes electrical conversion means which reduce the voltage and the amount of electrical power available and communicate the reduced voltage as an output signal and a luminaire portion which is selectively coupled to the converter portion to receive the output signal.

It is a second non-limiting advantage of the present invention to provide a voltage conditioner assembly. Particularly, the voltage conditioner assembly receives a signal of the alternating current type, wherein the voltage conditioner includes a power factor control circuit which outputs an amount of electrical power of the direct current type. A plurality of direct current-to-direct current (“DC-DC”) converters are coupled to the power factor circuit output. Each DC-DC converter limits the amount of electrical power available at its output terminals which are connected through an EMI filter to a modular jack to which one or more luminaires may be selectively and removably coupled.

It is a third non-limiting advantage of the present invention to provide a method for providing electrical power to illuminate one or more gas discharge lamps. Particularly, the method includes the steps of: providing a limited source of electrical power; coupling the source of electrical power to the luminaire; and providing the electrical power which is necessary for the proper starting and operation of a gas discharge lamp(s).

These and other features and advantages of the present invention will become apparent from a reading of the detailed description of the preferred embodiment of the invention in combination with perusal of the attached drawings.

### BRIEF DESCRIPTION OF THE DRAWINGS

FIG. 1 is a diagram of a lighting system which illustrates possible configurations made in accordance with the teachings of the present invention.

FIG. 2 is a block diagram of the voltage conditioner portion of a lighting system shown in FIG. 1.

FIG. 3 is a block diagram showing the interconnection of and the basic function blocks of the luminaire portion which is shown in FIG. 1.

FIG. 4 is a block diagram showing an alternate embodiment of the interconnection of the luminaire portion which is shown in FIG. 1.

### DESCRIPTION OF THE PREFERRED EMBODIMENTS OF THE INVENTION

Before the present methods and apparatuses are disclosed and described, it is to be understood that the terminology used herein is for the purpose of describing particular embodiments only and is not intended to be limiting. It must be noted that, as used in the specification and the appended claims, the singular forms “a”, “an”, and “the” include plural referents unless the context clearly dictates otherwise.

Further, it should be appreciated that many terms should be defined. Particularly, these terms are as follows:

1. The term “housing”, as used herein, is defined as a substantially rigid structure or container functional to enclose, house, contain and/or support an electronic circuit and/or a collection or assembly of electrical and/or electronics type parts and/or components.

2. The term “junction box”, as used herein, is defined as a substantially rigid box-like structure having a substantially flat bottom with a regularly shaped periphery, all along which periphery a wall is perpendicularly disposed and fastened, thereby to form a box or a container with a flat bottom entirely circumscribed by a perpendicularly disposed wall of substantially uniform height. The wall is so constructed to facilitate, or at least permit, fastening thereto of a top cover. The top cover, when in place, is operative to cover the aperture represented by the top of the wall. The flat bottom may have one or more apertures, as may as well the wall. When in place, the top cover may be said to constitute a top for the box-like structure. The top cover may itself have one or more apertures and may, or may not, include a housing.

3. The term “terminal”, as used herein, is defined as any electrically conductive body or element to which another electrical conductor may be connected and to which an electrical current may be delivered and/or from which an electrical current may be received.

4. The term “modular plug”, as used herein, is defined as the type of plug-like connector having a pair of output terminals from which electrical power may be provided and which is similar to the type commonly mounted at the end of a telephone cable used for making a releasable plug-in connection with the handset of a telephone instrument or used for making connection between such a telephone instrument and a wall-mounted telephone receptacle. It is noted, however, that this type of plug-like connector need not be identical to the plug-like connector commonly mounted at the end of such a telephone cable.

5. The term “modular jack”, as used herein, is defined as the type of receptacle, albeit not necessarily identical to, found on most ordinary non-wireless telephone handsets and used for receiving and holding a telephone-type plug wherein the receptacle is effective to electrically receive the pair of terminals found in a modular plug.

6. The term “voltage conditioner”, as used herein, is defined as any device or structure having an input port and an output port and being operative to receive an input voltage or an input current at its input port and to supply at its output port an output voltage or an output current, and where either the output voltage or the output current is different in at least one significant parameter as compared respectively with the input voltage and the input current.

7. The term “power line voltage”, as herein used, is defined as an alternating voltage: (i) existing across a pair of terminals; (ii) having an approximately sinusoidal waveform; (iii) having a fundamental frequency of 60 Hz or 50 Hz; (iv) having an open-circuit magnitude of between 100 and 400 Volt RMS; and (v) being supplied from a source of internal impedance so low as to permit a current of more than 10 Ampere RMS to be drawn from these terminals without causing the magnitude of the voltage present thereacross to drop significantly below the open-circuit magnitude.

8. The term “aperture”, as used herein, is defined as an opening in a box, a container, or a wall; which opening, except if expressly stated otherwise, has a planar periphery (i.e., a periphery lying flat in a plane). Thus, for instance, a shoe box without a lid is a container with an aperture having a planar periphery;

with the lid being shaped and proportioned so as to cover this aperture when properly placed onto the shoe box.

9. The term “luminaire”, as used herein, is defined as a product including: (i) a structure having input terminals operative to connect with a source of voltage or current; (ii) an electric lamp having lamp terminals and being supported in or by said structure; and (iii) conductors or a voltage conditioner, such as a high frequency DC to AC converter configured to operate as a ballast, connected between the input terminal and the lamp terminals.

10. The term “fire initiation hazard”, as used herein, is defined as being: (i) a hazard of causing initiation of fire excessively associated with an electrical circuit having output terminals from which power in excess of 100 Watts may be extracted for an extended period of time; and/or (ii) in accord with the intent, provisions and/or definitions associated with Class 1, Class 2 and/or Class 3 Power-Limited Circuits, as set forth in Article 725 of the 1999 National Electrical Code issued by the National Fire Protection Association, Quincy, Mass. 02269-9101.

11. The term “electromagnetic interference filter” or “EMI filter”, as used herein, is defined as any device, electrical component—and/or assemblage of components having an input port and an output port and being operative to attenuate and/or suppress the transmission of high frequency alternating voltages and currents while providing for the unimpeded transmission of direct current and low frequency alternating voltages and currents.

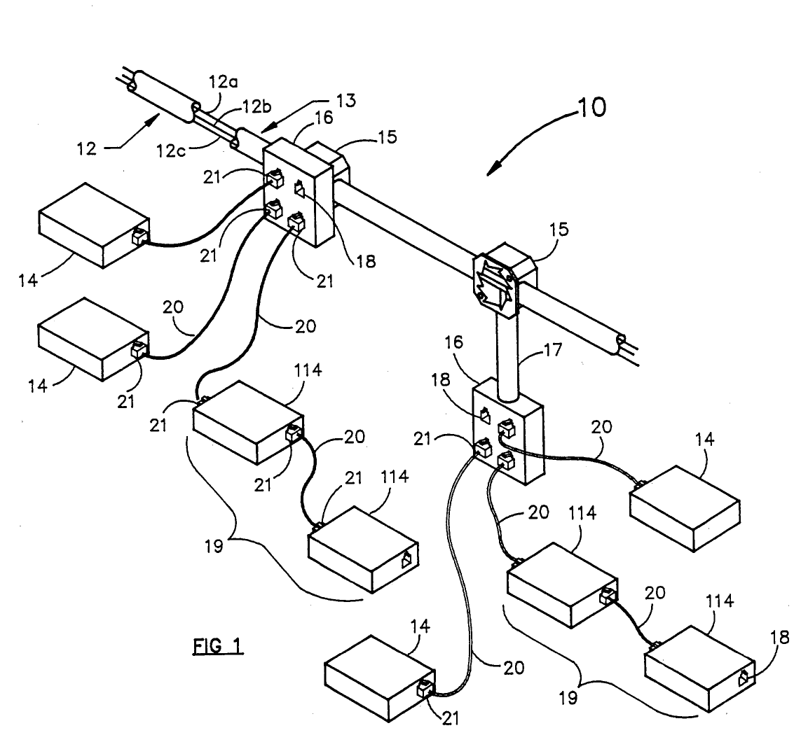

Referring now to FIG. 1, there is shown therein a lighting system 10 which is made in accordance with the teachings of the present invention and which is adapted to be selectively coupled to source of electrical power, such as alternating current or “AC” electrical power line 12, and to at least one luminaire 14, 114. In this manner, the system 10, as is more fully delineated below, selectively transfers some of the electrical power which may be provided by the source 12 to the luminaire 14, effective to selectively energize the luminaire 14 and to cause the luminaire 14 to generate or emit light energy. It should be appreciated that the present invention is not limited to a particular type of luminaire 14. Rather, the present invention may be used with any of a wide variety of luminaires.

As shown in FIG. 1, the power line 12 is generally distributed via a pair of conducting wires 12a, 12b and an electrical ground wire (green wire) 12c which are disposed within a conduit, armored cable, or flexible cable 13 according to the local electrical code. Junction boxes 15 are provided to make connections to the power line 12. An alternating current to direct current or “AC-DC” converter or “voltage conditioner” 16 may be mounted either directly upon a junction box or in a convenient remote location (e.g., coupled to the junction box 15 by a length of conduit or cable 17 containing electrical lines similar to lines 12a, 12b, and 12c) and provides one or more identical output ports 18 into which luminaires 14 may be plugged or connected.

As will be described in greater detail below, a non-limiting alternative type of luminaire 114 having a second modular jack 18 may be coupled or “daisy-chained” 19 to another luminaire 114 provided the total power requirements of the individual luminaries 114 do not exceed the power limitation of an output port of the voltage conditioner 16.

It should be appreciated that voltage conditioner 16 is coupled to junction box 15 in a manner which is effective in directing electrical power from power line 12 into voltage conditioner 16.

Further, lighting system 10 also includes at least one electrical interconnection cable 20 which electrically connects the voltage conditioner 16 to a luminaire 14. Each interconnection cable 20 includes a flexible pair of insulated conductors terminated at each end by a modular plug 21. As will be discussed in greater detail below, the voltage between the conductors does not present a shock hazard and since the power available is limited, the cable 20 can be “lightweight” (i.e., small conductors with minimal insulation), and does not have to be run in conduit or any type of protective sheathing.

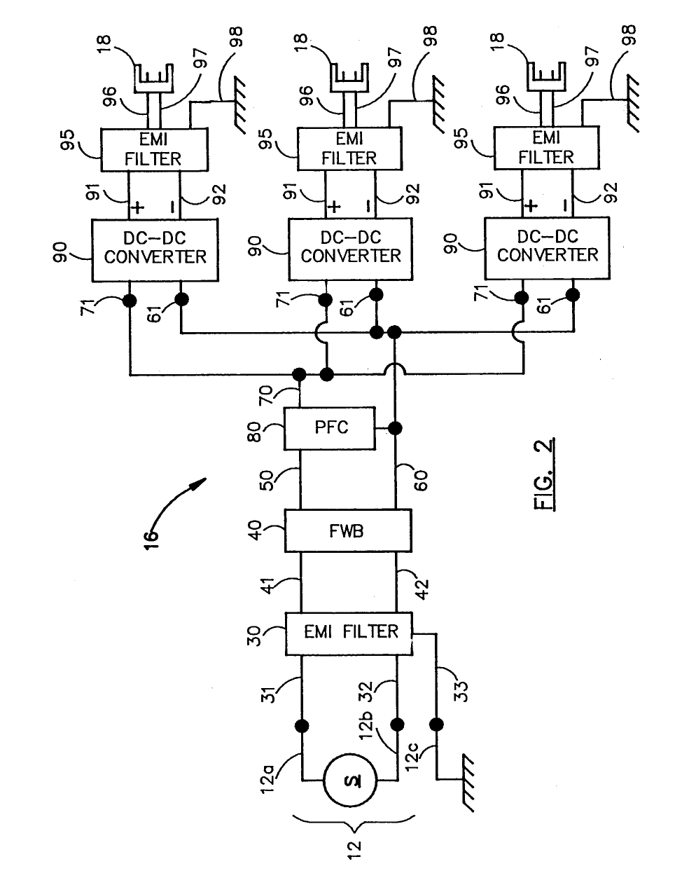

FIG. 2 depicts the block diagram of the preferred embodiment of a voltage conditioner 16 of lighting system 10. Source 12 of power line voltage (i.e., conductors 12a, 12b) is connected to the two input terminals 31, 32 of an electromagnetic interference or “EMI” filter 30. The EMI filter ground 33 is connected to earth ground by means of the power line ground lead (green lead) 12c or by connection to the junction box 15 on which the voltage conditioner 16 is mounted. The EMI filter 30 is coupled to a full wave bridge (“FWB”) rectifier 40 via electrical buses 41, 42. FWB rectifier 40 is further electrically connected to bus bars 50, 60.

Bus bars 50, 60 are connected to a power factor control (“PFC”) circuit 80. The output of the PFC circuit 80 is applied to bus bar 70. A plurality of direct current-to-direct current or “DC-DC” converters 90 are connected to bus bars 60, 70 (i.e., each DC-DC converter 90 includes a pair of terminals 61, 71 which are each respectively coupled to bus bars 60, 70). The positive and negative outputs 91, 92 of each DC-DC converter 90 are connected to a second EMI filter 95, one filter 95 for each DC-DC converter 90. Each output pair, positive 91 and negative 92, is isolated from the DC input and may be isolated from every other DC-DC converter output. The EMI filter 95 outputs 96, 97 are connected to a unique modular jack 18. Connections from the EMI filter ground 98 to earth ground are made by means of the power line ground (green lead) 12c or by connection to the junction box 15.

It should be appreciated by one skilled in the relevant art that the number of DC-DC converters 90, EMI filters 95, and modular jacks 18 contained within a particular voltage conditioner 16 and which are shown in FIGS. 1 and 2 are merely for illustrative purposes and the applications of the present invention may include more or less than the number of DC-DC converters 90, EMI filters 95, and modular jacks 18 depicted.

The operation of the AC-DC converter 16 of FIG. 2 may be explained as follows: Power line or source 12 includes two power leads 12a, 12b and one earth ground connection 12c and provides power line voltage to the lighting system 10 and more specifically to AC-DC converter 16. An electromagnetic interference (“EMI”) filter 30 attenuates electrical noise generated by the lighting system 10. As should be appreciated by one skilled in the relevant art, such noise may be conducted on the power lines 12 or be radiated from the circuit and lines attached to the converter 16. Both conducted and radiated noise may be the result of differential mode noise, where the noise signal follows the same path as the power signal and/or the result of common mode noise, where the noise spikes are equal in magnitude and in phase on the power lines and have a circuit path through ground. In an EMI filter, such as filter 30, conducted noise is impeded by inductors and shunted to earth ground through capacitors. A good connection to earth ground is preferably made to the green lead 12c of the power system 12 but also may be effected by connection to the junction box 15 upon which the AC-DC converter 16 is mounted.

The output of EMI filter 30 is connected via buses 41, 42 to a conventional full wave bridge (“FWB”) rectifier 40 which provides full wave rectified current in a conventional manner to the buses 50, 60 where bus 50 is positive with respect to bus 60. A conventional power factor control (“PFC”) circuit 80 is coupled to buses 50, 60 and switches an inductor across buses 50, 60 for a controlled length of time which is short compared to the time of a half cycle of the power line voltage. An amount of energy is stored in the magnetic field of the inductor proportional to the square of the magnitude of the current. When the switch opens, the collapsing magnetic field causes the voltage across the inductor to assume a level that allows the current to continue in a smooth manner. The energy stored in the magnetic field is delivered to the load and/or stored in a capacitor for use later in the cycle. By controlling the length of the ON pulse on a pulse-by-pulse basis, the current from the power line is close to in-phase with the power line voltage (close to unity power factor) and the harmonic content of the current waveform is low (low harmonic distortion). The output voltage from a PFC circuit, such as PFC circuit 80, is a direct current (“DC”) voltage having a substantially constant magnitude which is communicated via buses 70, 60 with the voltage communicated on bus 70 being positive with respect to the voltage communicated on bus 60. It should be appreciated that there are numerous PFC control integrated circuits, such as the Motorola MC33262, which may be employed and the above description is for exemplary purposes only.

A plurality of direct current-to-direct current (“DC-DC”) converters 90 are each connected to buses 70, 60 via respective terminals 71, 61. The DC-DC converter 90 reduces the high voltage DC output of the PFC circuit 80 to a substantially lower level and isolates the DC output from the DC input to eliminate potential shock hazard. In addition, the power output of the DC-DC converter 90 is limited so as not to be a potential fire initiation hazard. The preferred embodiment is a flyback-type DC-DC converter with power limiting on the primary side of the transformer and isolated outputs, such as-described in the data sheet for the Motorola MC33060A pulse width modulation circuit. It should be appreciated that there are many ways this reduction in DC output voltage and power limiting may be implemented. The now reduced DC voltage of each DC-DC converter 90 is communicated upon respective positive and negative terminals 91, 92 and is filtered by a second EMI filter 95, which functions substantially identical to EMI filter 30 described above to further reduce any electrical noise from the system 10, and is then communicated to a modular jack 18 through filter outputs 96, 97. The EMI filter 95 functions so that the differential and common mode noise generated within the AC-DC converter 16 is attenuated to reduce the radiated noise from the interconnection cables 20 to an acceptable level.

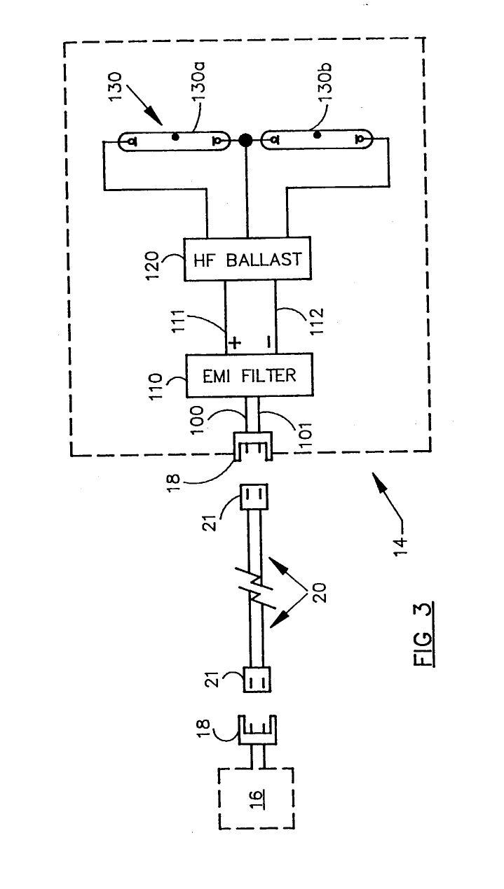

Referring now to FIG. 3, a two-conductor cable is terminated at each end with a modular plug 21 to form an interconnection cable 20. One modular plug 21 mates with and electrically couples the modular jack 18 on the voltage conditioner 16 and the other modular plug 21 on the opposite end of interconnection cable 20 mates with the modular jack 18 on a luminaire 14.

As shown, the luminaire 14 receives electrical energy from the interconnection cable 20 via the two electrical leads 100, 101 from the modular jack 18 which are connected to an EMI filter 110. EMI filter 110 includes two filter outputs 111, 112 (i.e., respective positive and negative voltage outputs), which are connected to a high frequency DC-AC converter configured to operate as a ballast circuit 120 which provides the starting voltage and current limiting to power at least one gas discharge (e.g., fluorescent) lamp 130. FIG. 3 illustrates the connection for two fluorescent lamps 130a, 130b operated in the instant start mode. It should be appreciated that each luminaire 14 receives conditioned electrical power from the lighting system 10 and generates the necessary voltage and current limiting required to start and operate gas discharge lamp 130, thereby causing the lamp to “glow” or emit light.

The modular plug 21 of interconnection cable 20 plugs into and electrically connects to the modular jack 18 on the luminaire 14. In the preferred embodiment of the invention, the plugs 21 and jacks 18 are polarized so that the positive and negative voltage or “plus and minus” supply leads are not interchanged. In an alternative embodiment of the invention, diodes (not shown) may be placed within the luminaire 14 and can be arranged to protect the luminaire 14 from reverse polarity (one diode) or can make the luminaire 14 insensitive to supply polarity (diode bridge).

The luminaire input jack 18 is connected via terminals 100, 101 to an EMI filter 110 which attenuates noise generated by the ballast circuit 120 so that the electrical noise or radiation is reduced to an acceptable level. The high frequency DC-AC converter ballast circuit 120 converts the DC input to high frequency (greater than 10 KHz) power for driving one or more gas discharge lamps 130. FIG. 3 shows the connection of two instant-start series-connected lamps 130a, 130b but other configurations and other modes of starting are not precluded.

In operation, the voltage conditioner 16 receives an alternating current type signal from the electrical power source 12 and converts the received signal to a direct current type signal, while concomitantly reducing the voltage of the signal. This conditioned signal is communicated to at least one modular output jack 18 and, via the lightweight interconnection cable 20, is made available to the luminaire 14. Moreover, as is more fully delineated above, the amount of is electrical power which is provided by the signal and which is communicated to the luminaire 14 is “automatically” limited (e.g., the term “automatically” means without human intervention) by the voltage conditioner 16. In this manner, relatively low voltage DC power is transmitted from voltage conditioner 16 through the “lightweight” interconnection cable 20 to a luminaire 14 in a safe and effective manner.

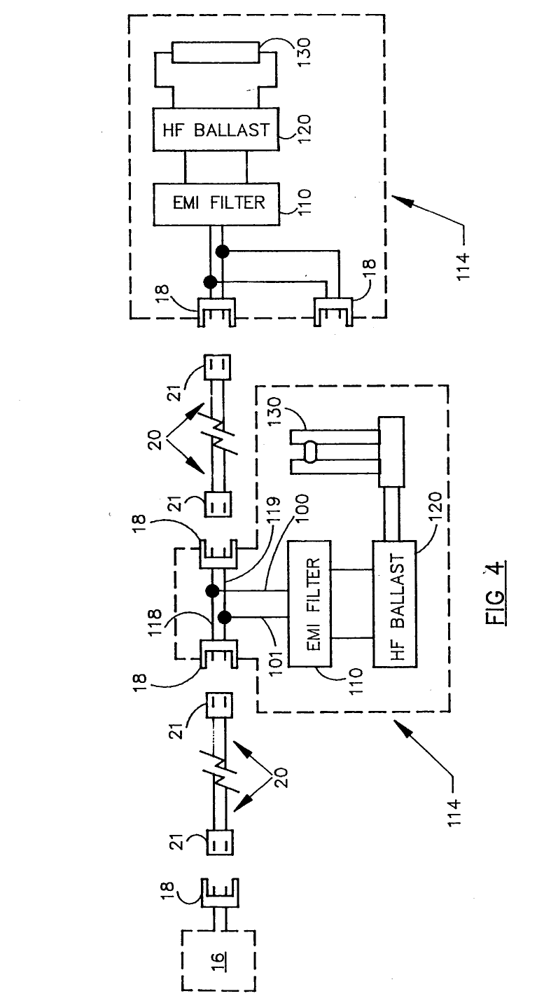

Referring now to FIG. 4, an alternate embodiment in which the luminaries 114 may be selectively coupled to the voltage conditioner 16 is illustrated, wherein the luminaires 114 are “daisy-chained” by providing a second interconnection cable 20. That is, two modular jacks 18 are mounted within each luminaire 114, wherein two buses 118, 119 are connected to second modular jack 18 and these buses 118, 119 are respectively coupled to electrical leads 100, 101 (i.e., jack 18 is connected in parallel). It should be appreciated that the first modular jack 18 is used to connect the DC supply from the AC-DC converter 16 and the other jack 18 is used to supply another luminaire 114 via a second interconnection cable 20.

Daisy-chaining of luminaires 114, as shown in FIG. 4, provides flexibility of luminaire types with few restrictions. It should be appreciated that the total power of all the daisy-chained loads must be less than the power limitation of the given output port 18. As described above, each luminaire 114 has its own EMI filter 110 and high frequency ballast circuit 120, while having two modular plugs 18 which permit the daisy-chain connection.

It is to be understood that the invention is not limited to the exact construction or methodology which has been delineated above, but that various changes and modifications may be made without departing from the spirit and the scope of the invention.

What is claimed is:

1. A lighting system comprising:
a source having first AC output terminals at which an AC voltage of relatively low frequency is provided;
an AC-to-DC converter having: (i) AC input terminals connected with the first AC output terminals, and (ii) DC output terminals at which is provided a DC voltage; the AC-to-DC converter including terminals between which exists a voltage having frequency components of such nature as to represent potentially undesirable electromagnetic interference (“EMI”) if allowed to leak to the AC input terminals or to the DC output terminals; the AC-to-DC converter including a first EMI filter operative to prevent such potentially undesirable electro-magnetic interference from leaking to the AC input terminal or to the DC output terminals; the first EMI filter including an inductor and/or a capacitor; and
a DC-to-AC converter having: (i) DC input terminals connected with the DC output terminals, (ii) second AC output terminals at which is provided an AC voltage of relatively high frequency; (iii) a lamp having a pair of lamp terminals connected with the second AC output terminals.

2. The lighting system of claim 1 wherein the DC-to-AC converter includes terminals between which exists a voltage having frequency components of such nature as to represent potentially undesirable electromagnetic interference if allowed to leak to the DC input terminals or to the second AC output terminals;
the DC-to-AC converter including a second EMI filter operative to prevent such potentially undesirable electromagnetic interference from leaking to the DC input terminal or to the second AC output terminals; the second EMI filter including an inductor and/or a capacitor.

3. The lighting system of claim 1 additionally comprising a flexible cable having at least two conductors and a first and a second end; a plug or a jack being connected with each end of the cable; the cable serving to provide electrical connection between the DC output terminals and the DC input terminals.

4. The lighting system of claim 1 wherein the first AC output terminals are mounted in rigid relationship with a junction box that is mounted in a substantially fixed and rigid relationship with a ceiling in a building, and the AC-to-DC converter is comprised within a housing mounted in a substantially rigid relationship with the junction box.

5. The lighting system of claim 1 wherein the source comprises a junction box mounted in a substantially fixed relationship with a ceiling in a building, and the AC-to-DC converter is comprised within a housing mounted in a substantially rigid relationship with the junction box.

6. The lighting system of claim 1 wherein the relatively low frequency is below 400 Hz and the relatively high frequency is above 10 kHz.

7. A lighting system comprising:
a source having first AC output terminals at which an AC voltage of relatively low frequency is provided; the first AC output terminals being mounted in a substantially fixed relationship with a junction box that is mounted in a substantially fixed relationship to a ceiling in a building;
an AC-to-DC converter having: (i) AC input terminals connected with the first AC output terminals, and (ii) DC output terminals at which is provided a first DC voltage; the AC-to-DC converter being comprised within a housing mounted in a substantially rigid relationship with the junction box;
a DC-to-AC converter having: (i) DC input terminals connected with the DC output terminals, and (ii) second AC output terminals at which is provided an AC voltage of relatively high frequency; the DC-to-AC converter being disposed at a location removed from the AC-to-DC converter by at least 24 inches; and
a lamp having a pair of lamp terminals connected with the second AC output terminals.

8. The lighting system of claim 7 wherein the AC-to-DC converter includes plural output ports; each output port having output terminals; the power and voltage outputs from these output terminals being manifestly limited so as to be safe from fire-initiation hazard.

9. The lighting system of claim 7 wherein the second AC output terminals are electrically isolated from the first AC output terminals.

10. The lighting system of claim 7 wherein the AC-to-DC converter includes plural output ports, each output port having output terminals at which is provided a second DC voltage characterized by being electrically isolated from said first AC output terminals.

11. The lighting system of claim 7 wherein the AC-to-DC converter includes plural output ports, each output port having output terminals at which is provided a second DC voltage characterized by being not representing an electric shock hazard.

12. The lighting system of claim 7 wherein the AC-to-DC converter includes plural output ports, each output port having output terminals characterized by being electrically isolated from the output terminals of another output port.

13. The lighting system of claim 7 wherein the AC-to-DC converter includes plural output ports, each output port being constituted as a jack or a plug, thereby permitting disconnectable connection between the AC-to-DC converter and the DC-to-AC converter.

14. A lighting system comprising:
a source having AC output terminals at which an AC voltage of relatively low frequency is provided; the AC output terminals being mounted in a substantially fixed relationship with a junction box that is mounted in a substantially fixed relationship to a ceiling in a building;
an AC-to-DC converter having: (i) AC input terminals connected with the AC output terminals, and (ii) plural output ports; each output port having a pair of DC output terminals from which is provided a DC output voltage;
plural DC-to-AC converters, each having: (i) DC input terminals connected with the DC output terminals of an output port, and (ii) a set of lamp output terminals at which is provided an alternating voltage of relatively high frequency; and
plural lamps; each lamp having lamp input terminals connected with a set of lamp output terminals of one of the plural DC-to-AC converters.

15. The lighting system of claim 14 wherein the DC output terminals of each output port is electrically isolated from the DC terminals of each other output port.

16. The lighting system of claim 14 wherein the DC voltage provided at the DC output terminals of any given output port is manifestly prevented from providing an electrical output of such character as to pose a fire initiation hazard.

17. The lighting system of claim 14 wherein the lamp output terminals are electrically isolated from the AC output terminals.

18. A lighting system comprising:
a source providing an AC power line voltage at a set of power line output terminals;
an AC-to-DC converter having: (i) AC input terminals connected with the power line output terminals; and (ii) plural output ports; each output port having a pair of DC output terminals from which is provided a DC output voltage;
plural DC-to-AC converters, each located remotely from the AC-to-DC converter and having: (i) DC input terminals connected with the DC output terminals of an output port, and (ii) a set of lamp output terminals at which is provided an alternating voltage of relatively high frequency; and
plural lamps; each lamp having lamp input terminals connected with a set of lamp output terminals of one of the plural DC-to-AC converters.

19. The lighting system of claim 18 wherein the DC output terminals are electrically isolated from the power line terminals.

20. The lighting system of claim 18 wherein the lamp output terminals are electrically isolated from the power line terminals.

21. The lighting system of claim 18 wherein the DC voltage provided at the DC output terminals of any given output port is manifestly prevented from providing an electrical output of such character as to pose a fire initiation hazard.

22. The lighting system of claim 18 wherein the DC voltage provided at the DC output terminals of any given output port is manifestly prevented from providing an electrical output of such character as to pose an electric shock hazard.

23. The lighting system of claim 18 wherein at least one of the DC-to-AC converters is located more than six feet from the AC-to-DC converter.

24. A lighting system comprising:
a source providing an AC power line voltage at a set of power line output terminals;
an AC-to-DC converter having: (i) AC input terminals connected with the power line output terminals; and (ii) plural output ports; each output port having a pair of DC output terminals from which is provided a DC output voltage;
plural DC-to-AC converters, each having: (i) DC input terminals connected with the DC output terminals of an output port, and (ii) a set of lamp output terminals at which is provided an alternating voltage of relatively high frequency; and
plural lamps; each lamp having lamp input terminals connected with a set of lamp output terminals of one of the plural DC-to-AC converters.

25. The lighting system of claim 24 wherein the DC output terminals are electrically isolated from the power line terminals.

26. The lighting system of claim 24 wherein the lamp output terminals are electrically isolated from the power line terminals.

27. The lighting system of claim 24 wherein the DC voltage provided at the DC output terminals of any given output port is manifestly prevented from providing an electrical output of such character as to pose a fire initiation hazard.

28. The lighting system of claim 24 wherein the DC voltage provided at the DC output terminals of any given output port is manifestly prevented from providing an electrical output of such character as to pose an electric shock hazard.

29. The lighting system of claim 24 wherein at least one of the DC-to-AC converters is located more than six feet from the AC-to-DC converter.

30. The lighting system of claim 24 wherein the DC output terminals of each output port is electrically isolated from the DC terminals of each other output port.

31. The lighting system of claim 24 wherein the DC output terminals of each output port is electrically isolated from the power line output terminals.

32. The lighting system of claim 24 wherein the AC-to-DC converter comprises a rectifier circuit and an inverter circuit; the inverter circuit including an energy-storing inductor operative, by intermittent on/off switching, to convert a first unidirectional voltage of a relatively low magnitude to a second unidirectional voltage of a relatively high magnitude.

33. A lighting system comprising:
a source providing an AC power line voltage at a set of power line output terminals;
an AC-to-DC converter having: (i) AC input terminals connected with the power line output terminals; and (ii) plural output ports; each output port having a pair of DC output terminals from which is provided a DC output voltage;
plural DC-to-AC converters, each having: (i) DC input terminals connected with the DC output terminals of an output port, (ii) a set of lamp output terminals at which is provided an alternating voltage of relatively high frequency; and (iii) an auxiliary output port at which is provided an auxiliary DC voltage at a set of auxiliary DC output terminals;
an auxiliary DC-to-AC converter having: (i) a set of auxiliary DC input terminals connected with the auxiliary DC-output terminals; and (ii) a set of lamp output terminals at which is provided an alternating voltage of relatively high frequency; and
plural lamps; each lamp having lamp input terminals connected with a set of lamp output terminals of one of the DC-to-AC converters.

34. A lighting system comprising:
a source providing an AC power line voltage at a set of power line output terminals;
an AC-to-DC converter having: (i) AC input terminals connected with the power line output terminals; and (ii) plural output ports; each output port having a pair of DC output terminals from which is provided a DC output voltage;
a DC-to-AC converter having: (i) DC input terminals connected with the DC output terminals of an output port, (ii) a set of lamp output terminals at which is provided an alternating voltage of relatively high frequency; and (iii) an auxiliary output port at which is provided an auxiliary DC voltage at a set of auxiliary DC output terminals;
at least one auxiliary DC-to-AC converter having: (i) a set of auxiliary DC input terminals connected with the auxiliary DC output terminals; and (ii) a set of lamp output terminals at which is provided an alternating voltage of relatively high frequency; and
gas discharge lamps, each having a set of lamp input terminals connected with a set of lamp output terminals.

35. The lighting system of claim 34 wherein at least one of the sets of lamp terminals include more than two lamp terminals.

36. The lighting system of claim 34 wherein each of the DC output terminals is electrically isolated from the power line output terminals.

37. The lighting system of claim 34 wherein the DC output terminals of one of the plural output ports in not electrically isolated from the DC output terminals of another one of the DC output terminals of another one of the plural output ports.

38. A lighting system comprising:
a source providing an AC power line voltage at a set of power line output terminals;
an AC-to-DC converter having: (i) AC input terminals connected with the power line output terminals; and (ii) an output port having a pair of DC output terminals from which is provided a DC output voltage;
a DC-to-AC converter-lamp combination: (i) having DC input terminals connected with the DC output terminals of an output port, (ii) having a set of lamp output terminals at which is provided an alternating voltage of relatively high frequency; (iii) having an electric lamp with a set of lamp input terminals connected with the set of lamp output terminals; and (iv) being disposed at a location some distance away from that of the AC-to-DC converter.

39. The lighting system of claim 38 wherein the DC-to-AC converter-lamp combination is located at least six feet away from the AC-to-DC converter.

40. The lighting system of claim 38 wherein the DC-to-AC converter-lamp combination is mounted in a suspended ceiling.

41. The lighting system of claim 38 wherein the DC-to-AC converter-lamp combination is further characterized by including an EMI filter.

42. The lighting system of claim 38 wherein the DC-to-AC converter-lamp combination is further characterized by not including any conductive terminals having electrical connection with one of the power line output terminals.

43. The lighting system of claim 38 wherein the AC-to-DC converter is further characterized by drawing a substantially sinusoidal current from the power line output terminals.

44. The lighting system of claim 38 wherein the DC output terminals are further characterized by not having electrical connection with the power line output terminals.

45. The lighting system of claim 38 wherein the DC-to-AC converter also includes an auxiliary output port at which is provided an auxiliary DC voltage of magnitude substantially equal to that of the DC output voltage.

46. The lighting system of claim 38 wherein the auxiliary DC voltage is manifestly prevented from providing an electrical output of such character as to pose a fire initiation hazard.

47. The lighting system of claim 38 wherein the relatively high frequency is higher than about 10 KHz.

48. The lighting system of claim 38 wherein the DC-to-AC converter-lamp combination is an integral part of a luminaire.

49. The lighting system of claim 38 wherein said luminaire is adapted to be mounted in a location such as a suspended ceiling.

50. A lighting system comprising:
a source providing an AC power line voltage at a set of power line output terminals;
an AC-to-DC converter having: (i) AC input terminals connected with the power line output terminals; and (ii) an output port having a pair of DC output terminals from which is provided a DC output voltage;
a luminaire including a DC-to-AC converter and a gas discharge lamp; the DC-to-AC converter having (i) DC input terminals connected with the DC output terminals of an output port, and (ii) a set of lamp output terminals at which is provided an alternating voltage of relatively high frequency; the lamp having a set of lamp input terminals connected with the set of lamp output terminals.

51. The lighting system of claim 50 wherein said luminaire is adapted to be mounted in a location such as a suspended ceiling.

52. The lighting system of claim 50 wherein said luminaire is located some distance away from the AC-to-DC converter.

53. The lighting system of claim 50 wherein said luminaire is located at least six feet away from the AC-to-DC converter.

54. The lighting system of claim 50 wherein the lamp draws a substantially sinusoidal current from the lamp output terminals.

55. The lighting system of claim 50 wherein the lamp draws power from the lamp output terminals at a power factor of at least 90%.

56. The lighting system of claim 50 wherein said alternating voltage has a substantially sinusoidal wave-shape.

57. The lighting system of claim 50 wherein said DC output voltage is of substantially constant magnitude.

58. The lighting system of claim 50 wherein the AC-to-DC converter draws power from the power line output terminals at a power factor of at least 90%.

59. The lighting system of claim 50 wherein the AC-to-DC converter draws a substantially sinusoidal current from the power line output terminals.

60. The lighting system of claim 50 wherein the DC-to-AC converter includes an EMI filter.

61. The lighting system of claim 50 wherein both the AC-to-DC converter and the DC-to-AC converter include an EMI filter.
